(19) United States
(12) Patent Application Publication
(10) Pub. No.: US 2005/0271282 A1
(43) Pub. Date: Dec. 8, 2005

(54) Method of encoding and decoding character trains

(75) Inventor: Frank Reckers, Dusseldorf (DE)

Correspondence Address: THE FIRM OF KARL F ROSS, 5676 RIVERDALE AVENUE, PO BOX 900, RIVERDALE (BRONX), NY, 10471-0900, US

(73) Assignee: MESSE DUSSELDORF GmbH

(21) Appl. No.: 11/006,493

(22) Filed: Dec. 7, 2004

(30) Foreign Application Priority Data
Jun. 5, 2004 (DE) 102004027616.1

(51) Int. Cl. G06K 9/18; G06F 15/16

(52) U.S. Cl. 382/229; 709/203

(57) ABSTRACT

A method of coding and decoding of character trains in data sets which can be called up in computer networks, whereby the character train has an address function or serves to call up an address function, in particular serving as an email address. By conversion of clear-text character trains to coded character trains and vice versa, each character of the clear-text character set has a particular other character of the coding character set associated in a one-to-one relationship therewith, whereby each character of the clear-text character train is substituted for in the data by a character in the coding character set and the decoding is effected by means of a called-up decoding routine. The call-up of the decoding routine is effected at the instant that the coded character train should be reproduced. The method is used for coding and decoding of email addresses and/or other address information and/or function call ups or function commands.

### FIELD OF THE INVENTION

My present invention relates to a method of encoding (coding) and decoding character trains in data sets which can be called up through a computer network and wherein the character train can have an address function and/or can call up an address function, especially an email address.

### BACKGROUND OF THE INVENTION

It is known, with character trains in data sets which can be called up in computer networks and in which the character train has an address function and/or serves to call up an address function, especially an email address, to mask the character train, rather than to provide it as a clear-text in the data set called up by the computer network, for example, by replacing each character of the character train by a singular or unique numerical character assigned thereto in one-to-one correspondence in the ASCII Standard.

This approach has served especially for the masking of Email addresses in source text of data sets, particularly in HTML format, which can be called up over the Internet and displayed by a so-called browser. The masking of individual characters by their unique numbers of the standard ASCII character set can be directly displayed using conventional viewing programs like those of browsers. The masking of a character train which serves especially as an email address prevents the typical character sequence of the email address, like for example, “name@domain.de” from appearing in the source text, since such character trains have a typical structure and can be readable in an automated manner by corresponding programs. The masking of email addresses or other character trains then can serve to avoid or prevent an automated reading of the character trains and an unauthorized use and reproduction of email addresses for transmitting undesired advertising literature (SPAM), etc., overloading of resources and the economic disadvantages thereof.

It is, however, a drawback of this system that there are also state of the art automated programs which can read character sets of different types from source text of data sets called up by computer networks and which can also interpret correctly the aforementioned masked character trains. The earlier masking techniques, therefore, do not provide adequate protection against automated reading and spying of such character trains.

### OBJECTS OF THE INVENTION

It is the principal object of the present invention to provide an improved method of masking a character train, especially a character train serving as an address indicator, such as an email address, or a character train which can be used to call up an address, whereby the aforedescribed disadvantage can be obviated.

Another object is to provide an improved coding/decoding method, especially for email addresses.

Yet another object is to so improve a method which can overcome the drawbacks outlined above and for coding and decoding character trains in a data set which can be called up in a computer network, whereby the character train has an address function and/or serves to call up such a function, especially of an email address, that automated reading and spying using such character trains is suppressed.

### SUMMARY OF THE INVENTION

This object is achieved in accordance with the invention in that a transformation from the clear-text character train to a coded character train and vice versa is carried out in that especially each character of the clear character set is in a unique, one-to-one relationship with another character of a coding character set, whereby each character of the clear character train is substituted by a character of the coding character train in the data and the decoding is effected by a decoding routine which can be called up at the moment at which the coded character train is to be reproduced.

Because each character of the clear character train in present in the data substituted by a character from the coding character train, the automated reading out of clear character trains from the data set and their use is reliably prevented.

According to a feature of the invention the decoding is effected by means of a decoding routine which is called up at the moment at which the coded character train is to be reproduced as a clear-text character train. In this case the user is able to obtain via the computer network and from the called up data set a correct display of the clear-text character train so that the computing cost for the decoding of the coded character train is minimal and for the user does not represent any noticeable delay.

According to a further feature of the invention, the decoding routine is a component of the same data set as that which contains the coded character train. The decoding routine is preferably run on a computer of the computer network which serves to call up the data over that network. In particular, the decoding routine can access over the computer network a data base in which the code is stored.

It has been found to be important for the clear-text character set and the coding character set to have the same characters. Advantageously the clear-text character set and the coding character set are identical with respect to a numerical sequence of the characters of the character set and each character set of the clear-text character set can be substituted by a character of the coding character set which is at the same numerical position along respective sequence as characters for which it is substituted in the clear-text character set.

The numerical position can be determined by a random number generator prior to coding and can be delivered together with the coded character train as the parameter. The sequence of the character in the two character sets can be generated by a random number generator.

In a best mode embodiment of the invention the clear-text character train is converted into a corresponding small-letter (lower-case) clear-text character train by a case conversion prior to coding.

When, for example, email addresses are coded in accordance with the process of the invention, for example in so-called HTML documents which can be called up over the internet and displayed with corresponding programs by a browser, directly in the source text there can be integrated a Java script function with serves for decoding the coded character train. In other words the coded character train thereby can be translated back to the associated clear character train and thus to the correct e-mail address. It is thus an advantage of the method of the invention, using corresponding viewing programs like a browser to interpret not only HTML but also Java script by providing a clear-text character train for the viewer which in the source text of the document is however coded and is thus not readable by automated programs since these programs are incapable of interpreting functions and script integrated in the document, but the document can be reproduced with the aid of detection programs for the viewer without any noticeable delay.

As has been noted, the decoding routine can be run on the computer which calls up the data through the computer network. The computer which calls up the data over the computer network usually serves to display the data with the aid of a corresponding viewing program. The viewing program is thus simultaneously capable of carrying out the corresponding decoding routine without a noticeable delay which has the advantage that no additional computing capacity is required on the part of the user or at the so-called server.

Preferably the decoding routine enables accessing via the computer network a data base in which the code is stored since the code and the decoding routine can be stored in different data sets and/or data bases, the security of the method of the invention against nonpermitted access or spying of the character train in the data sets is further increased.

Through the use of a content management system (CMS) for character trains stored in a data base, especially email addresses, the character trains can be read out of the data base by a coding routine in the CMS and thereby coded so that they appear, even in the CMS display, in their coded versions as they can then be reproduced in data sets called up through the computer network that is in the source text for example of HTML documents.

In a preferred embodiment the clear text and the coded text sets have the same characters as noted earlier thereby simplifying the method of the invention without lessening the degree of security. It is not required to store different character sets but only the substitution rule for each individual character of the clear character set by a unique associated character of the coding character sets.

I have also noted that the clear character set and the coding character set should be identical and that the characters following in the same sequence so that each character of the clear-character set can be substituted by a character of the coding character set which is in the same fixed numerical spacing along the respective sequence. This allows a single character set with a fixed sequence of the characters to be used with the substitution determined only by an offset in the numerical value along the clear-character and coding character sequences. The decoding can be effected in the reverse way. This is especially advantageous because it means that both the coding and decoding will utilize only a minimum of calculating cost and time.

The numeral offset between the coding set and the clear set can be produced by a random number generator prior to coding and can be supplied together with the coded character train as the parameter. That also ensures a high level of security of the method against unauthorized access to the coded clear-character train.

It has been found to be especially advantageous, moreover to generate the data set which is called up through the computer network with the aid of a content management system only at the moment at which the computer network receives a corresponding request therefor. In this case, with the aid of the content management system and especially within the document to be displayed or the data set, email addresses to be reproduced therefrom are read out and simultaneously the numerical offset is produced by the random number generator prior to coding and transferred as the parameter so that this parameter in the form of the numerical offset passes as a dynamic value during the production of the data set called up by the computer network through the content management system. The decoding routine thus integrated in the data set or a separate decoding routine which can be called up apart from the data set can correctly convert the coded character train into the corresponding clear-character train. The additional generation of the order of the characters identical clear and coding character sets by means of a random number generator provides a further increase in security.

In a preferred embodiment, as noted, the case of the clear-character chain will be converted to small characters prior to coding. That means that to the extent that the clear-character train contains large characters, those characters will be converted to the corresponding small characters. It is especially advantageous when the character trains do not distinguish or require distinguishing between upper and lower cases as for example is the situation with email addresses. As an alterative thereto or cumulatively, during coding and decoding of character trains which serve as email addresses, apart from the email address itself, like for example “name@domain.de” a corresponding function command like “mailto:” can be provided as a prefix to the email address and can serve to call up corresponding programs for transmitting the email to the given address and such prefix can be coded together with the email address.

An especially advantageous use of the method of the invention is thus in the coding and decoding of email addresses and other addresses and for function commands and the call up of particular functions. These include, in addition to email addresses, the ordinary addresses or telephone and telefax numbers or names of individuals which, while correctly reproducible through corresponding programs like browsers, are usually not capable of being read out automatically. Using the coding (and decoding) of the present invention, personal information in data sets which can be called up on a computer network can be so coded that they will not be readable in an automated, for example by so-called search engines.

The invention can also serve to protect the structure of a data base against unauthorized access by the coding and decoding for example of hyperlinks and/or other reproduction parameters.

### BRIEF DESCRIPTION OF THE DRAWING

The above and other objects, features, and advantages will become more readily apparent from the following description, reference being made to the accompanying drawing in which:

FIG. 1 is an algorithm flow diagram illustrating an embodiment of the invention for the coding of a clear-character train serving as an email address; and

FIG. 2 is a corresponding diagram for the decoding of a coded character train, likewise serving as an email address.

### SPECIFIC DESCRIPTION

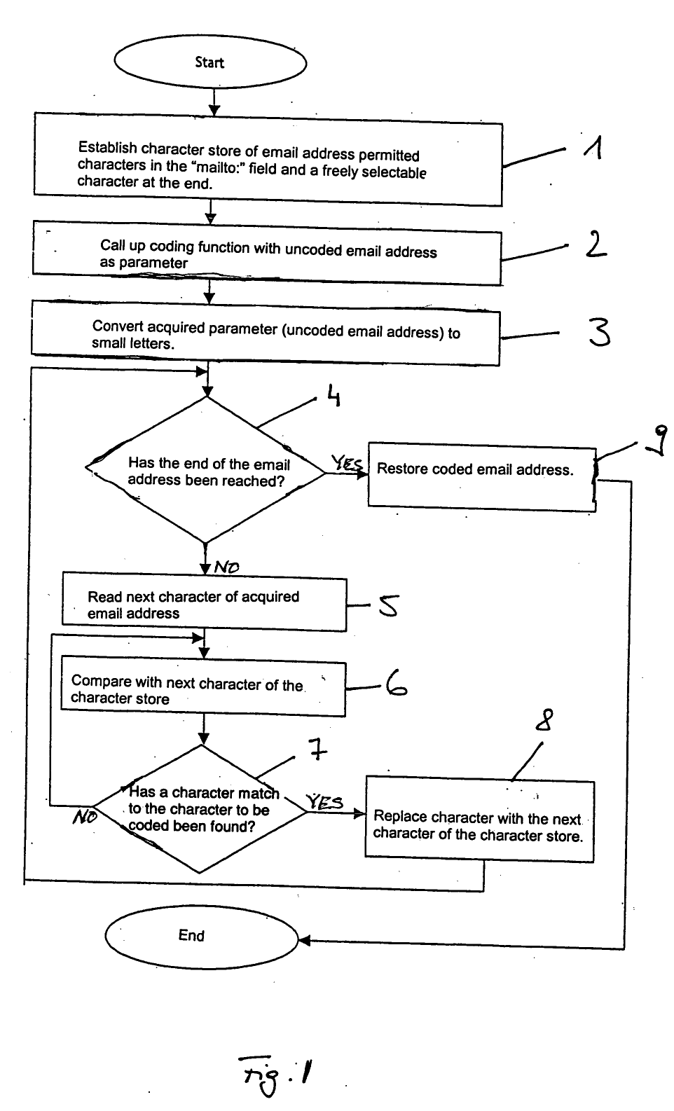

FIG. 1 shows an algorithm for the coding of a clear-character train in accordance with the invention in which in a first step 1, a character store is established of permitted characters in the “mailto:” field for the email address and a freely selectable character at the end. This character store then should encompass all of the characters allowed in any email address as well as the characters contained in the “mailto:” and a freely selectable additional character at the end of the email address. This freely selectable character serves to mark the end of the clear-character train to be encoded and functions as a mark which signals that the end of the clear character train to be encoded has been reached and the repetitive call up of the coding routine is to be stopped.

In the second step 2 of the method, the coding function is called up with the clear-character train in the form of the encoded email address utilized as the parameter. The clear-character train to be coded can, in addition to the characteristic email address in the form “name·domain.de” have the prefix “mail@:” attached thereto as the function call up prefix.

The delivered parameter, that is the clear-character train corresponding to the encoded email address, is subjected to a case conversion in the third step 3 of the method to small or lower-case characters. This is especially important where the email address normally will not distinguish between upper case and lower case.

In the fourth stage 4, based upon the additional character applied in step 1, to mark the end of the clear character train to be tested, this character train is tested to determine whether the end of the email address has been reached. To the extent the answer to this test is in the negative, in the fifth stage 5, the next character of the acquired email address is read and in the sixth stage 6 is compared with the next character of the character store established in step 1.

In the seventh step 7, a test is made as to whether the actual character to be coded agrees with the next character of the character store of step 1. If this is not the case, the method jumps back to step 6, i.e. the comparison of the character to be coded of the clear-character train with the now further character of the store established in step 1. Upon agreement in step 7 of the character to be coded in the comparison character from the character store, the coded character in step 8 is replaced with that next character of the character store. Thus in step 8 of the method there is a substitution of the clear character by a coded character such that the nth character of the character store corresponding to the character to be coded is replaced by the (n+1)^{th} of the store prepared in step 1 as the corresponding coding character for the coded character train. In step 8 the process returns to the fourth step 4 and is repeated until the end of the clear character train, namely the end of the email address is reached as marked by the additional character at the end of the clear-character train.

When the end of the clear-character train is reached, the test in stage 4 is affirmative, triggering the ninth step 9 to output the coded email address as the coded character train. This coded character train, of course, no longer has the typical character sequence of the email address, for example, “name@domain.de” and thus can no longer be read automatically. Preferably the character train which is outputted corresponds to the character sequence: mailto:givenname.name@domain.de”.

Initially in the sequence the data set, comprised of the characters permitted in the email address, should be modified or completed to include the “mail.:” characters and the additional freely selectable character for marking the end of the character train.

The coding of an email address as provided herein can thus use the following character set:

“a”, “b”, “c”, “d”, “e”, “f”, “g”, “h”, “i”, “j”, “k”, “l”, “m”, “n”, “o”, “p”, “q”, “r”, “s”, “r”, “u”, “v”, “w”, “x”, “y”, “z”, “1”, “2”, “3”, “4”, “5”, “6”, “7”, “8”, “9”, “0”, “@”, “_”, “−”, “.”, “:”, “ ”

What is important is the sequence of the characters used since these should be identical for both the encoding and the decoding. In that case each character need only be provided once and the coding thereby expanded as desired.

To mark the end of the clear-character train, for example the character “#” is used.

Previously the email address “givenname.name@domain.de” was present in the source text of the data set which could be called up through the computer network, for example HTML data accessible by browser in its visible and clear-character form.

The sequence of the characters used for encoding and decoding in the data set is optional and can be individually selected or matched to any desired pattern, but preferably is obtained by random number generation.

The email address to be encoded in the example given herein is “givenname.name@domain.de”. The first character “g” is replaced in the sequence of the character set by the next character, in this case by the character “h”, since the character “h” in the character set selected for encoding and decoding has the “h” following the character “g”. The characters are replaced in a similar manner in the coding of the clear-character train. That means that the email address is coded in accordance with this pattern, namely each character of the clear-character train is replaced by the following character in the character set to produce the coded character train. In this limiting example the offset is therefore 1. The offset step can of course be any positive or negative natural number, selected optionally as preferably by a random number generator. The same character set can be repeated any number of times in the original sequence to allow any size offset which may be desired.

The entire clear-character train coded in this example, using the “#” as the final character to indicate the end of the train thus is:
“mailto:givenname.name@domain.de#”

When coded with a step width or offset 1, the coded character train will read:
“nbjmup hjwfnobnf:obnf_epnbjo:ef”

This, of course includes the coded email address:
“hjwfnobnf:obnf_epnbjo:ef”

The coded character trains are not identifiable as email addresses.

The decoding takes place in accordance with the same principle as the coding but in the opposite direction, i.e. in this example each character of the coded character set is replaced by a previous character during the decoding. The important thing is that the character set uses the identical to the character set in the coding.

Beginning with the first character of the coded character set, each character of the coded email address will be replaced by the preceding character in the sequence and rather than the step width being “+1” as was the case for encoding, the width or offset is here “−1”. The step width here corresponds to the step width of coding but is of the opposite sign and, like the step width of encoding, must be optionally selected before the coding is effected.

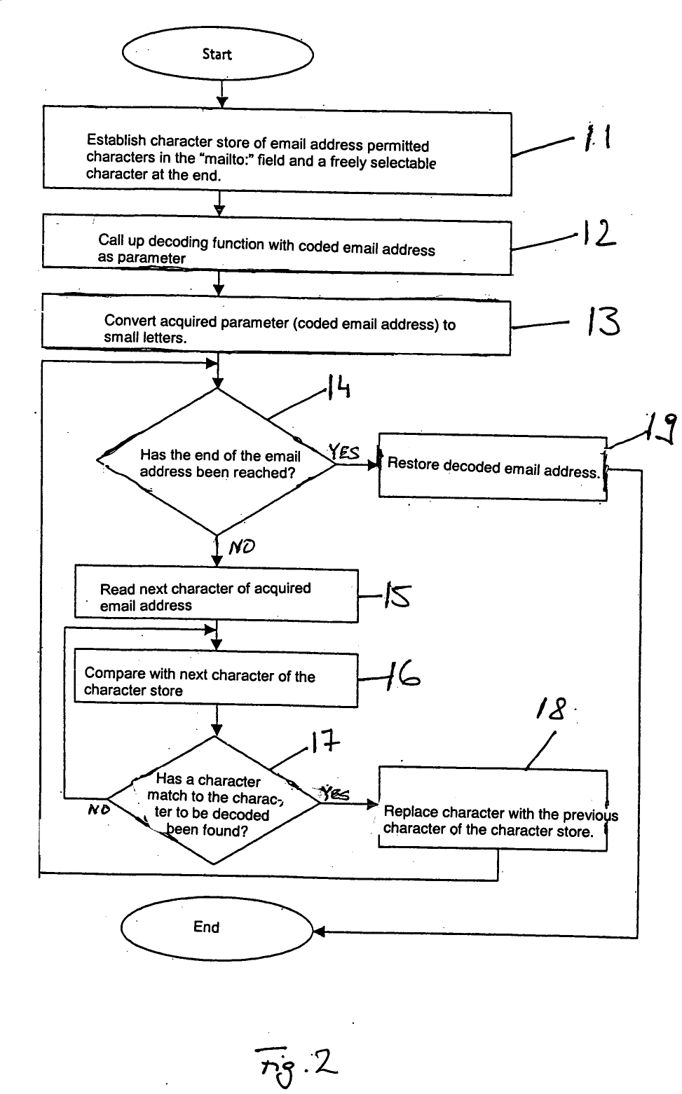

FIG. 2 is an algorithm diagram similar to FIG. 1 showing the decoding operation.

In the first step 11 a character store is established. The character store for decoding must correspond to the character store used for coding both with respect to the characters thereof and with respect to the sequence of characters as established in step 1 of FIG. 1. A freely selectable additional character is here also provided at the end of the coded character train which here is the coded email address. This character is freely selectable and serves solely to mark the end of the coded character train to terminate the repetition of the decoding sequence when that last character is reached.

In the second step 12 of the decoding process the decoding function is called up. The coded character train serves as a parameter for this purpose and can include the coded form of the email address “name@domain.de” preceded by the coded form of “mailto:” as described.

The delivered parameter, namely the coded email address in the form of a train of coded characters is converted i the third step 13 to lower case. That is especially of advantage when distinctions are not made between upper case and lower case characters in the email address.

In the fourth step 14, a determination is made as to whether, based upon the presence of the freely selectable character from step 11, the end of the email address has been reached. If the test is negative (step 15) the next character of the coded character train supplied as the parameter is read and in the sixth step 16 is compared with the next character of the character store created in stage 11.

In the 17th step 17, a test is made as to whether a character match to the character to be decoded has been found. If this is not the case, the process jumps to block 16, namely the 6th stage to repeat the character comparison. If a match has been found at 17, the character is replaced with the previous character of the character store, i.e. a character stage that each nth character of the coded train is replaced with the (n−1)^{th} clear character (step 18).

Following step 18 the process returns to stage 14 until the last character of the train is reached. If the last character is reached (affirmative in the test at 14), the decoded mail address is produced at 19. The email address, again in the form of “name.domain.de” can then be reproduced correctly in an appropriate display program such as a browser.

It has been found to be especially advantageous for the decoding routine to be integrated in the data set which can be called up over the computer network, for example in the form of Java script code together with the requisite character store for decoding so that the display program or browser can directly carry out the decoding routine and produce directly the clear-character train.

In this example, the coded train
“nbjmup hjwfnobnf:obnf_epnbjo:ef”

This is translated to
“mailto:givenname.name@domain.de”

The latter provides directly the email address in the form of “givenname.name@domain.de”. The source text of the data set, e.g. an HTML document however contains only the coded form which is identifiable as an email address.

The encoding and decoding can also be carried out in other programming languages such as VB-Script, PHP or Perl.

Alternatively, the lengths of the character train to be encoded or decoded can also be determined prior to delivery to the coding and decoding routine and treated as the parameter. In this case the additional character at one end can be eliminated.

1. A method of coding and decoding a character train in a data set which can be called up in a computer network and can have an address function including an email address function or can serve to call up a function, the method comprising converting a clear-text character train to a coded character train or a coded character train to a clear-text character train such that each character of the clear-text character set is associated one-to-one singularly with a respective certain character of the coding character set whereby each character of the clear-text character train is found substituted by a character of the coded character train in the data, the decoding is effected by means of a decoding routine which can be called up, and whereby the decoding routine is called up at the moment at which the coded character train is to be reproduced.

2. The method defined in claim 1 wherein the decoding routine is a component of the same data set as that containing the coded character train.

3. The method defined in claim 2 wherein the decoding routine is run on a computer which serves to call up the data over the computer network.

4. The method defined in claim 3 wherein the decoding routine accesses over the computer network a data base in which the code is stored.

5. The method defined in claim 4 wherein the clear-text character set and the coding character set have the same characters.

6. The method defined in claim 5 wherein the clear-text character set and the coding character set are identical with respect to a numerical sequence of the character sets and each character of the clear-text character set is substituted by a character of the coding character set which is at the same numerical position along the respective sequence as the character for which it is substituted in the clear-text character set.

7. The method defined in claim 6 wherein the numerical position is determined by a random generator prior to coding and is delivered together with the coded character train as the parameter.

8. The method defined in claim 7 wherein the sequence of the characters of the identical clear-text and coding character sets is generated by a random number generator.

9. The method defined in claim 8 wherein the clear-text character train is converted into a corresponding small-letter clear-text character train prior to the coding.

10. The method defined in claim 1 wherein the decoding routine is run on a computer which serves to call up the data over the computer network.

11. The method defined in claim 1 wherein the decoding routine accesses over the computer network a data base in which the code is stored.

12. The method defined in claim 1 wherein the clear-text character set and the coding character set have the same characters.

13. The method defined in claim 1 wherein the clear-text character set and the coding character set are identical with respect to a numerical sequence of the character sets and each character of the clear-text character set is substituted by a character of the coding character set which is at the same numerical position along the respective sequence as the character for which it is substituted in the clear-text character set.

14. The method defined in claim 13 wherein the numerical position is determined by a random generator prior to coding and is delivered together with the coded character train as the parameter.

15. The method defined in claim 13 wherein the sequence of the characters of the identical clear-text and coding character sets is generated by a random number generator.

16. The method defined in claim 1 wherein the clear-text character train is converted into a corresponding small-letter clear-text character train prior to the coding.
